(19) United States
(12) Patent Application Publication
(10) Pub. No.: US 2008/0114627 A1
(43) Pub. Date: May 15, 2008

(54) System and Method for Capturing Process Instance Information in Complex or Distributed Systems

(75) Inventors: Stefan A. Baeuerle, Malsch (DE); Roger W. Kilian-Kehr, Darmstadt (DE); Meinert Holger, Muehlhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/560,185

(22) Filed: Nov. 15, 2006

(51) Int. Cl. G06Q 10/00; G06F 17/30

(52) U.S. Cl. 705/7

(57) ABSTRACT

A system and method for capturing and information about a process instance in a business system is provided. A unique process instance identifier may be assigned to each business object created, used, or modified during execution of the process instance. The identifier may then be used to monitor or analyze the process instance during execution or at a later time. The system and method may include steps and procedures to allow for cases where the process instance identifier is not propagated from a single predecessor object to a single successor object and other extraordinary situations.

### RELATED APPLICATIONS

This application is related to co-pending U.S. application Ser. No. 11/560,014, filed Nov. 15, 2006 (Attorney Docket No. 11884/497101), the disclosure of which is incorporated by reference in its entirety.

### BACKGROUND

When mapping business processes to technical processes, a business system may create and use a variety of data objects. As a business process is performed, many such data objects may be created and manipulated. For example, when a purchase contract is implemented in a business system, multiple purchase orders, customer invoices, and other types of business objects may be involved. While a specific set of business objects may be related in a workflow (i.e., a specific set of steps in a process), it may be difficult or impossible to view execution of the entire business process within the system. Efforts to view or manipulate a process instance may further be complicated when business objects are involved in multiple process instances, or when a business system spans multiple organizations such as suppliers, customers, and manufacturers.

### BRIEF DESCRIPTION OF THE DRAWINGS

FIG. 1 shows a process instance with a process instance identifier assigned to business objects according to an embodiment of the present invention.

FIG. 2 is a schematic diagram showing the structure of a process instance identifier assigned to a node in a business object according to an embodiment of the present invention.

FIG. 3 shows the structure of a message for propagating a process instance identifier according to an embodiment of the present invention.

FIG. 4 shows process instance identifiers assigned to successor business objects according to an embodiment of the present invention.

FIG. 5 shows process instance identifiers assigned to nodes in a business object according to an embodiment of the present invention.

FIG. 6 shows assignment of process instance identifiers after an interruption in the propagation chain according to an embodiment of the present invention,

FIG. 7 shows execution of process instances and analysis of a process instance according to an embodiment of the present invention.

FIG. 8 shows an exemplary process for assigning a process instance identifier to a business object according to an embodiment of the present invention.

FIG. 9 shows an exemplary process for constructing a process instance using process instance identifiers according to an embodiment of the present invention.

FIG. 10 shows a business system implementing process instance identifiers according to an embodiment of the present invention.

FIG. 11 shows an exemplary user interface for analyzing a process instance according to an embodiment of the present invention.

### DETAILED DESCRIPTION

Embodiments of the present invention provide systems and methods for analyzing and/or tracking process instances within a complex business system by use of a process instance identifier. A process instance may be defined by a chain of business objects that results from the execution of one or more business scenarios. For example, a process instance may include manufacturing orders, deliveries, invoices, and other items associated with a purchase order. The process instance may represent a user's expectation of the behavior of a business system, in contrast to, for example, a workflow that defines built-in steps performed by a business system to accomplish a specific task. A process instance may include multiple workflows and/or business objects from a variety of workflows. The process instance also may span multiple systems, such as third-party systems and systems run by business partners. For example, a purchasing contract may result in multiple purchase orders. The process instance associated with the purchasing contract may include all the business objects created and/or manipulated for each purchase order, or each purchase order may be a separate process instance. Each purchase order may interface with a third-party system for billing, and may require information received via a communication medium outside the business system such as by facsimile. Embodiments of the present invention provide a way to track a process instance where there is an interruption between predecessor and successor business objects resulting from execution of the process instance.

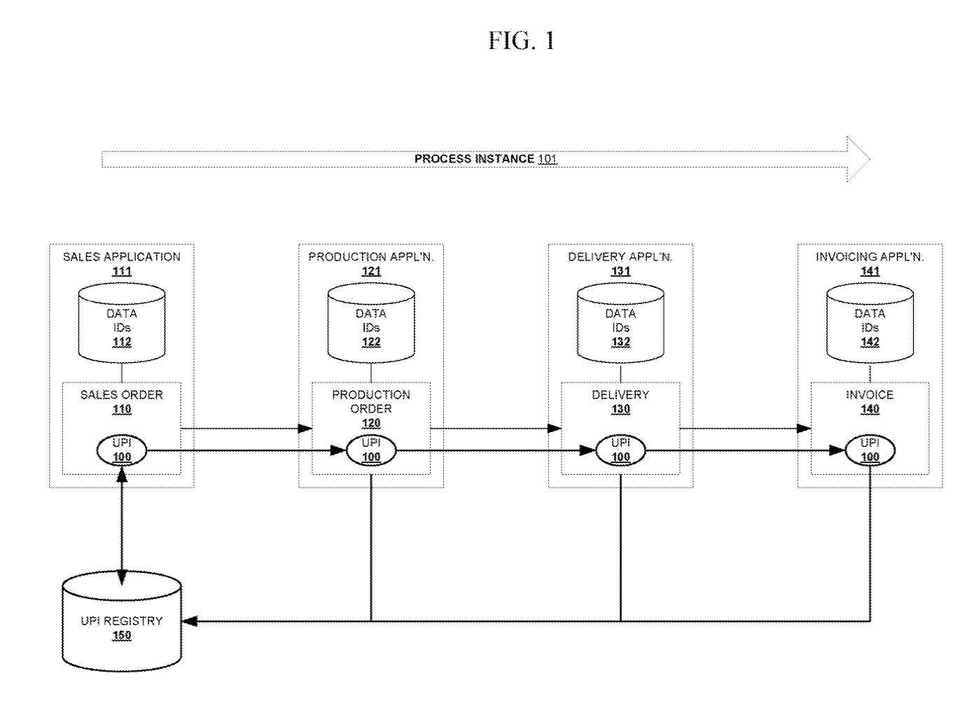

FIG. 1 shows an exemplary business system which may contain multiple applications such as sales 111, production 121, delivery 131 and invoicing 141. Each application may use its own data and processes 112, 122, 132, 142, respectively, which may be internal to the application (i.e., not shared between applications). When the applications execute processes in a business system, business objects may be created that store and manipulate data within the application. Each business object may be assigned a unique identifier within the application. For example, a sales order 110 may have a unique identifier within the sales application 111. The application may store a record of the internal identifier assigned to each business object, such as in the internal database 112, 122, 132, 142 used by each application. In this regard, the structure and operation of enterprise management systems are well known.

The process instance 101 shown in FIG. 1 may be, for example, a process used in receiving and processing a customer order. When a sales order is received, a sales order business object 110 may be created in the business system. Since the sales order does not have a predecessor business object (i.e., a business object that must be created before the sales order business object can be created, or that generated the sales order business object), a new, UPI 100 is created and assigned to the sales order object. As used herein, a “Universal Process Identifier” (UPI) refers to an identifier associated with a business process instance. By propagating a UPI through the business objects involved in the process, each business object involved in execution of the process instance may be identified and made available for analysis. A record of the UPI may also be stored in a UPI registry 150. The specific format and/or value of the UPI 100 may be determined by the business system after consulting the registry 150. For example, it may be desirable to assign sequential UPIs to process instances as they are executed. In such a case, the business system may consult the UPI registry 150 to determine the next sequential UPI to be assigned. In an embodiment, the internal identifier assigned to the initial business object in a process instance (such as the sates order 110 in FIG. 1) may be used as the UPI for the process instance.

As the process instance 101 is executed by the business system, the UPI 100 may be propagated to successor business objects. In the example, the sales order 110 generates a production order 120. When the production order 120 is generated, the UPI 100 may be assigned to the production order. Similarly, the UPI may be assigned to each subsequent business object, such as a delivery object 130 and an invoice object 140. Each time the UPI is propagated to a successor business object, a record of the UPI and the business object to which it is assigned may be stored in the UPI registry 150. The registry may be used for later analysis, such as reconstructing a business process instance from a selected business object or displaying business objects generated during execution of a selected process instance.

In an embodiment, a process instance may represent a collection of business objects that represent a logical process as perceived by a user of the system, as opposed to a set of steps defined in the business system. By propagating UPIs through the business objects generated during execution of a process instance, a business system may present a process instance even if the related process is not pre-defined in the business system. For example, a business system may have pre-defined workflows for creating and approving a purchase order. As perceived by a user, these workflows may be part of the same process even though they are separately defined in a business system. That is, it may be more meaningful to a user to analyze a process that encompasses both workflows instead of each workflow individually. In an embodiment of the invention, a business system may use UPIs to present the process instance encompassing both workflows to the user.

In an embodiment, each UPI may be unique within the business system, i.e., each process instance may be associated with a single UPI, and/or each UPI may be associated with a single process instance. However, the same UPI may, and generally will be assigned to multiple business objects when each business object is part of a process instance associated with the UPI. In some cases a business object may be associated with multiple UPIs. For example, when a successor business object stores information related to two predecessor business objects, each of which is part of a separate process instance, the successor business object may store the UPI assigned to each of the predecessor objects.

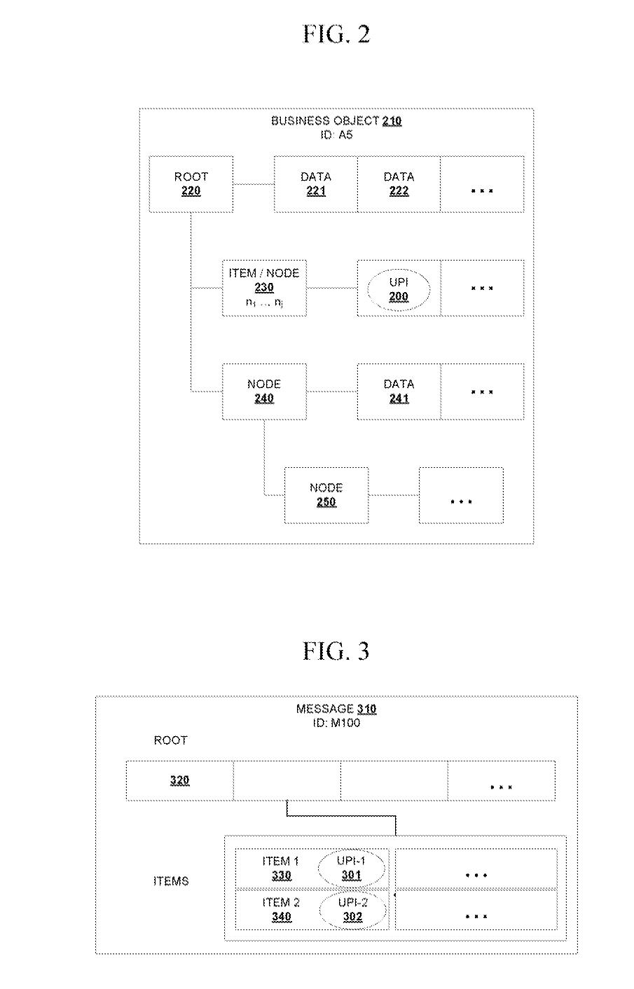

Process instances may be more complex than the example described with reference to FIG. 1. For example, a business object type may have a hierarchical structure involving multiple nodes as shown in FIG. 2. A business object 210 may have a root node 220 and various levels of child nodes 230, 240, 250. Each node may have data 221, 222, 241, such as attributes of the node, associated with it. Each root node may include different types of items, such as n nodes of type x, and m nodes of type y. Each type may be assigned a UPI, i.e., one UPI may be assigned for all nodes of type x and a second UPI for all nodes of type y. Each instance may also be assigned a UPI. In the example shown in FIG. 2, a UPI 200 is assigned to “item” nodes. The UPI may be stored as an attribute of the corresponding node. As shown in the example, a business object may have an identifier (“A5” in FIG. 2) within the application that generates the business object. Such identifiers are typically internal to the application, and are not sent or shared between applications. In contrast, in embodiments of the invention UPIs may be transferred from a predecessor business object to a successor business object when the objects are part of the same process instance.

Various methods may be used to assign UPIs. For example, a single UPI may be assigned to each node of the same type, i.e., the UPI of each item node n, is the same, UPI(nⱼ)=UPI(nⱼ). As another example, a UPI may be assigned to each item node UPI(nⱼ)≠UPI(nⱼ) for i≠j. For example, in cases where the business process is controlled, it may be advantageous to assign UPIs based on items of a particular type. When the second exemplary method is used, various mechanisms may be applied to allow tracking of process instances and to maintain consistency among UPIs. If a business object may have, or is known to have multiple predecessors (such as a purchase order generated from multiple purchase requests), a UPI may be assigned to each item node, or to the nodes of another level in the hierarchy if the node's predecessor is unknown. In general, business objects and nodes may be treated in a similar fashion when assigning and manipulating UPIs. Unless specifically indicated otherwise herein, the term “business object” therefore may refer to a business object or to a node stored within a business object. The assignment of UPIs is further described below.

Business systems may employ a number of separate components or sub-systems, such as customer relations management, supply chain management, and other systems. Some components may be run by business partners, and may be built on third-party systems that interface with the business system. Such distributed systems may communicate by transmitting and receiving messages in a standardized format. The structure of an exemplary message providing information about items in a business object is shown in FIG. 3. A message 310 may contain various items 320, 330, 340, each of which may have associated properties, attributes, etc. As previously described, the message 310 may be assigned an identifier (“M100” in FIG. 3) within the system. For example, a record of each message may be stored in a database, where the ID of the message identifies its location in the database. However, such identifiers typically are not propagated to the application or business object receiving the message. In an embodiment of the invention, a UPI may be propagated via a message, allowing the sending and receiving business objects to be linked to the same process instance. To propagate UPIs 301, 302 associated with each item between systems or components, the UPIs 301, 302 assigned to each item 330, 340, respectively, may be stored as an attribute or property of the associated item. When a remote system receives such a message, it may further propagate the UPIs to additional business objects.

Additional details regarding the operation of UPIs in general use scenarios are given in U.S. application Ser. No. ______, filed ______ (Attorney Docket No. 11884/497101). Embodiments of the present invention provide systems and methods having increased flexibility in assigning and using UPIs in complex business systems.

In an embodiment, a business object may spawn multiple independent successor business objects. For example, a purchasing contract business object may spawn several purchase order business objects. If the basic UPI assignment technique is used, each purchase order business object may be assigned the same UPI, i.e., the UPI of the purchasing contract business order. However, it may be desirable to analyze each spawned business object and subsequent business objects as a separate process instance. In such a situation, the business system may incorporate a rule indicating each spawned business object may be assigned a new UPI.

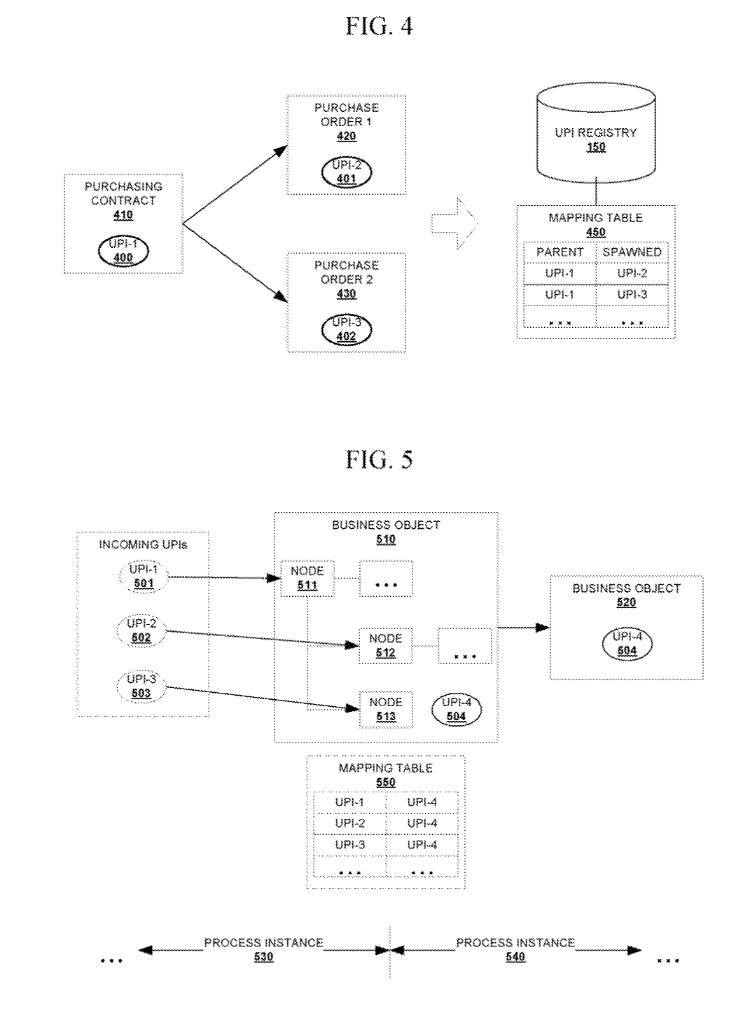

FIG. 4 shows a schematic view of such a situation. A purchasing contract 410 may be created in a business system and assigned UPI-1 400. When the purchasing contract 410 spawns two purchase orders 420,430, each of the purchase order business objects may be assigned a new UPI 401, 402, respectively. A “mapping table” 450 may be used to record the relationship between the parent UPI 400 and each spawned child UPI 401, 402. The mapping table 450 may be implemented as part of the UPI registry 150, or it may be recorded in a separate storage medium, device, or area of the business system. A mapping table records relationships between UPIs associated with business objects, and may allow for rapid reconstruction of a process instance in cases where a standard predecessor/successor relationship is not present or is complicated by multiple predecessors and/or successors. The mapping table may also be omitted, or specific parent/child UPI relationships not recorded. For example, when there is no need to maintain process instance continuity between the parent object and any spawned objects, the mapping table may be omitted.

In some cases, it may be useful to define the end of a process instance at a point when there is no longer a clear predecessor/successor relationship between business objects. For example, there may be a point in a process instance where there is an n:1 or n:m relationship between business objects instead of a 1:1 or 1:n relationship. A mapping table as previously described may be used to link the UPI of the “ending” process instance with the UPI of a subsequent process instance.

FIG. 5 shows a specific example where multiple “incoming” UPIs, i.e., UPIs which would be assigned from a predecessor object to a successor object, are assigned to different nodes of a business object. As previously described, a business object 510 may have a hierarchy of nodes 511, 512, 513. For example, a customer invoice business object may contain a separate UPI for each invoice item. The nodes may be assigned UPIs 501, 502, 503 based on the UPIs of various predecessor objects (not shown). A UPI may be assigned to the business object 510 and propagated to a successor business object 520. By assigning a new UPI to the business object 510 having nodes with different predecessor UPIs, the business object 510 and associated UPIs may serve as an implicit mapping table. That is, a record of the UPI 504 and its relationship to the incoming UPIs 501, 502, 503 may be used by the business system in a manner similar to a mapping table as previously described. In an embodiment, an explicit mapping table 550 may also be created. A mapping table may also be omitted if no link is desired. For example, a business object 510 may be the end of a first process instance 530 and the beginning of a second process instance 540. If no link between the two instances 530, 540 is desired, the mapping table 550 and/or any stored relationship between the new UPI 504 and the incoming UPIs 501, 502, 503 may be omitted.

Analyzing a process instance using process instance identifiers may be advantageous over other methods of analyzing a process instance. For example, in some business systems each business object may store an indication of its predecessor and successor business objects. The system could thus iteratively examine each business object to select predecessor and successor objects and construct a process instance. However, such methods may be time and/or computationally expensive. For example, a business object may have multiple predecessor and/or successor objects. Reconstructing a specific process instance may therefore require a thorough analysis of the predecessor-successor relationships between the various business objects, the use of each business object in a typical process, and the specific role of each business object in each possible process instance. When a process instance identifier according to an embodiment of the invention is used, such analysis may be reduced or removed. Embodiments of the invention therefore may allow for process instances to be constructed and analyzed relatively easily and quickly.

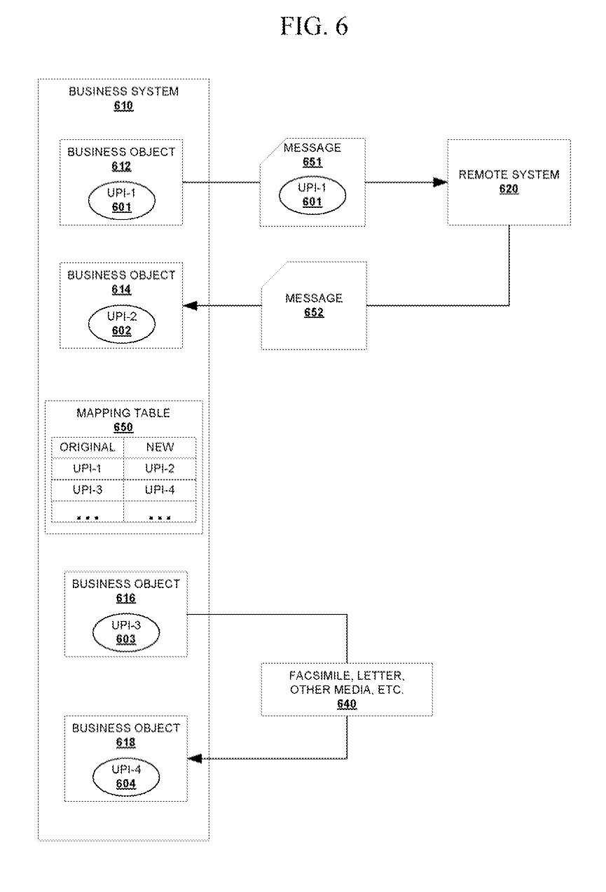

It may be possible for the UPI propagation mechanisms used in a business system to be interrupted. For example, a business system may interface with a remote system, such as that of a business partner or a third party. The remote system may not be configured to propagate the UPI through subsequent process steps performed on the remote system, FIG. 6 shows examples of interruption and subsequent correction of the UPI chain in a business system. A business system 610 may generate a business object 612 and assign a UPI 601 to the business object as previously described. If the business system interfaces with a remote system, it may send a message 651 to the remote system 620. For example, if the remote system is that of a manufacturer, the message 651 may contain information describing a manufacturing order (quantity, color, model number, etc.). As part of the UPI propagation mechanism, the message 651 may include the UPI 601 to be propagated through the process instance. After the remote system completes the appropriate tasks in the process instance, it may send a message 652 to the business system. If the remote system does not implement UPI propagation, the message 652 may not include the UPI 601 associated with the process instance A resulting business object 614 created in the business system therefore may be assigned a new UPI 602.

In another scenario, the UPI chain may be interrupted when information or process steps utilize communications outside the business system. For example, data may be generated by a first business object 616 having a UPI 603. As part of a business process the data may be transmitted between departments or to a business partner via facsimile, letter, or other media 640. If another business object 618 is subsequently created, it may be assigned a new UPI 604 even though it is created during the process instance associated with the first UPI 603 since the UPI was not propagated. The UPI chain may be repaired by analyzing the relationship between the first object 616 and the second object 618. When the UPI chain is repaired after an interruption, a mapping table 650 may be created to record relationships between UPIs present before and after the interruption. The mapping table 650 may then be used to reconstruct a process instance where the UPI propagation chain has been interrupted.

In cases where the UPI chain is reconstructed after an interruption, various methods may be used to link a new UPI to a previous UPI in the chain. For example, when the UPI chain is interrupted due to use of a remote or third-party system, the response received from the remote system may include an internal identifier of a previous business object. As previously described, a business object may have an identifier assigned by the generating application. This identifier may be sent to a remote system and returned by the remote system as part of a routine communication between the systems. When a new business object is generated in response to such a message, the internal identifier of the previous business object in the chain may be used to determine the UPI assigned to the previous business object. In an embodiment, the newly-generated business object may be assigned a new UPI, and the new UPI linked to the UPI of the previous business object. In an embodiment, a predecessor UPI may be identified based on the function of the business object in a workflow, task, or other structure of the business system. As a specific example, a new payment business object may be created based on information received via a medium outside the business system, such as a facsimile or letter. When the new business object is created, a new UPI may be assigned to the object. The business system may identify a predecessor business object, such as an invoice, based on the received information, such as the goods for which payment was received, the amount of payment, or other information. The UPI assigned to the new object may then be linked to a UPI assigned to the predecessor object. Other methods may be used to link a new UPI to a predecessor UPI after the UPI chain is interrupted and/or repaired.

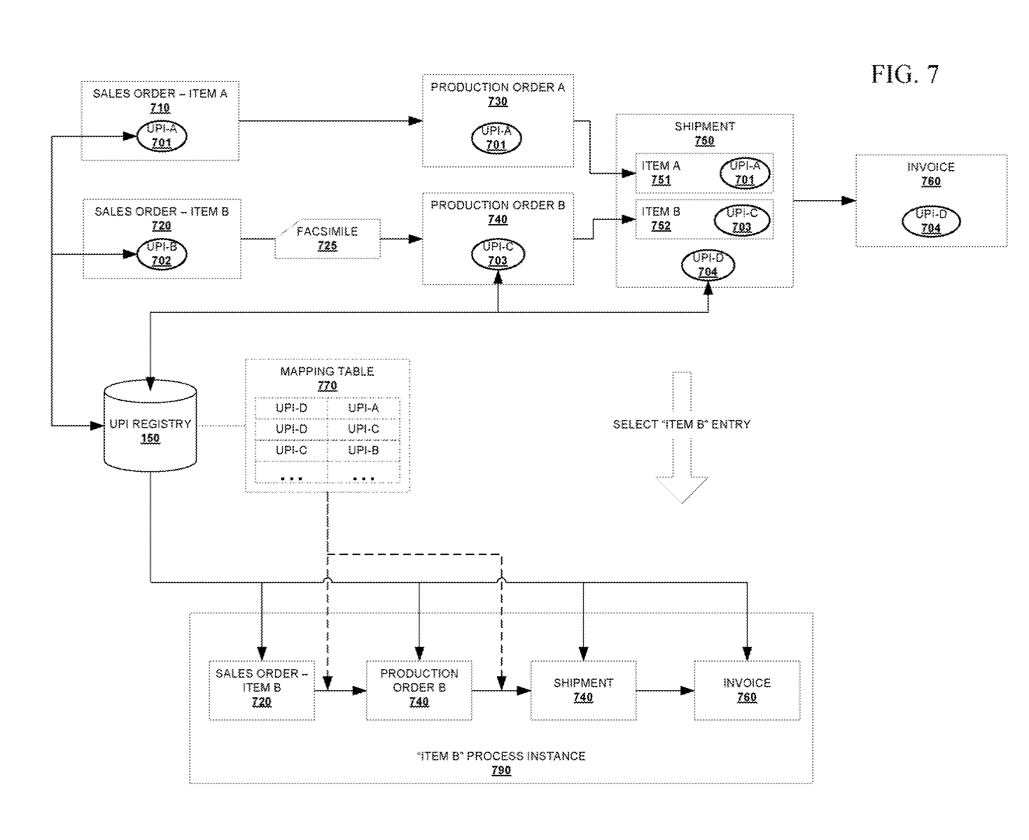

When a UPI is propagated through each business object involved in a process instance, the process instance may be reconstructed for analysis as shown in FIG. 7. The example shown in FIG. 7 may represent a simplified process instance or set of process instances related to purchase, production, and delivery of an order. The processes shown are intended to be illustrative, and may not represent every element or step of a real process. For example, some systems and procedures that would be present in a real process may be omitted for clarity. In the example shown, a customer may place an order for item A, resulting in the creation of a first sales order 710. When the sales order is created, a new UPI 701 may be assigned. If a UPI registry 150 is used, the assigned UPI 500 may be determined by and/or stored in the UPI registry 150 as previously described. A second order for item B may similarly result in the creation of a second sales orders 720 and associated UPIs 702. In the example, items A and B may be manufactured by different business partners, causing a separate production order 730, 740 to be created for each sales order 710, 720, respectively. The second production order 740 may be transmitted by a medium outside the business system, such as a facsimile 725. For example, the system to which the second production order 740 is to be sent may not interface directly with the business system.

Where the production order 730 is created directly by or in response to the sales order business object 710, a UPI 701 may be propagated from the sales order to the production order. Where the UPI propagation chain is interrupted such as between the second sales order 720 and the second production order 740, a new UPI may be assigned as previously described. A record of UPIs assigned as the result of a break in the UPI propagation chain may be recorded in a mapping table 770.

After the ordered products have been manufactured, a shipment business object 750 may be created. The UPIs 701, 703 associated with each production order may be propagated to items 751, 752 of the shipment business object. In an embodiment, a new UPI 704 may be assigned to the shipment business object. For example, the new UPI may be assigned if the business system defines the creation of a shipment business order as the end of a process instance. The new UPI may then be propagated to successor objects such as an invoice 760. A mapping table 770 may be used to link the new UPI 704 with UPIs 701, 703 of items in the shipment business object 750.

It may be desirable for a user of the system to track a process instance as it occurs in the business system, or to analyze a process instance at a later time. For example, the process instance associated with an item in an invoice business object may be of interest, such as when a customer disputes an entry on the resulting invoice. A user may select an item of interest, such as the item A node 752 in the shipment business object 750. The system may then reconstruct the process instance 790 associated with the selected item 752, for example by selecting each business object and/or node that is assigned the same UPI 703 as the selected item. For example, if a UPI registry is used, each entry in the registry 150 having a record associating a business object or node with the UPI 703 of the selected item may be retrieved and presented in order. As another example, the system may iteratively “step” through the process instance. Using this method, the selected item 752 is examined to determine the assigned UPI 703 and the predecessor business object 740. The predecessor is then similarly examined, until the initial business object (i.e., one having no predecessor) is reached. The process instance could then be assembled by iteratively examining the selected object 752 and each of its predecessor and successor objects.

If the process instance to be analyzed involves business objects that were assigned a new UPI due to an interruption of the UPI propagation mechanisms, a mapping table may be used to construct the process instance. For example, if a process instance is requested for the invoice business object, a mapping table 770 may be used to determine that the predecessor object 750 is linked to items having separate UPIs 701, 703. In the example shown, UPI-D (704) has two linked UPIs—UPI-A (701) and UPI-C (703). The mapping table 770 may be stored with or in a UPI registry 150. The mapping table(s) may also be a separate entity within the business system.

Once each business object involved in the process instance has been selected, the instance 790 associated with the selected item may be displayed or provided for manipulation and/or analysis. A schematic view 790 may be displayed to the user, which may include relationships between business objects. For example, predecessor/successor relationships may be displayed by directed arrows. Other information and relationships may be displayed, and a variety of formats may be used. The system may provide only those business objects and/or nodes directly involved in the process instance, as shown in FIG. 7, or it may provide all business objects and/or nodes in each related process. Providing related business objects and/or nodes may be useful to provide information about a selected node's relationship to a larger variety of process instances, business objects and/or nodes.

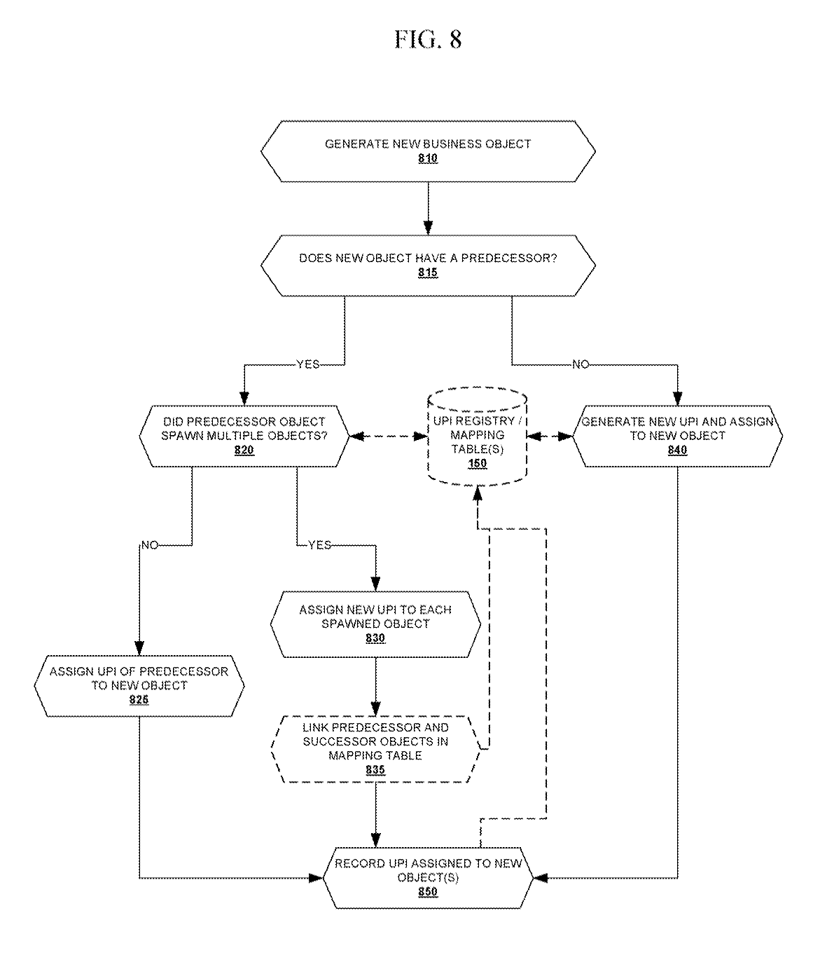

FIG. 8 shows an exemplary process for creating and assigning UPIs according to an embodiment of the invention. As part of a process instance, a new business object may be generated 810. When the object is generated, the system may determine whether the new object has a predecessor 815. If there is a predecessor object, the system may also determine whether the new business object was spawned by a predecessor object, and if so whether the spawning object spawned multiple new business objects 820. If the predecessor object spawned only the new business object, the UPI of the predecessor object may be assigned to the new object 825. If a business object spawned multiple successor objects, each new object may be assigned a new UPI 830. The UPIs of the spawning object and the spawned successor objects may be recorded (835) in a mapping table 150 as previously described.

If the new business object does not have a predecessor, such as when the new business object is the initially-created object in a process instance, a new UPI may be generated and assigned to the new object 840. In each step 820, 840, 850, a UPI registry 150 may be used to determine the UPI assigned to a predecessor object or the appropriate UPI to generate and assign to the new business object. Once the appropriate UPI is determined and assigned to the new business object, a record of the UPI and information about the business object may be stored in the system 850, such as in the UPI registry 150.

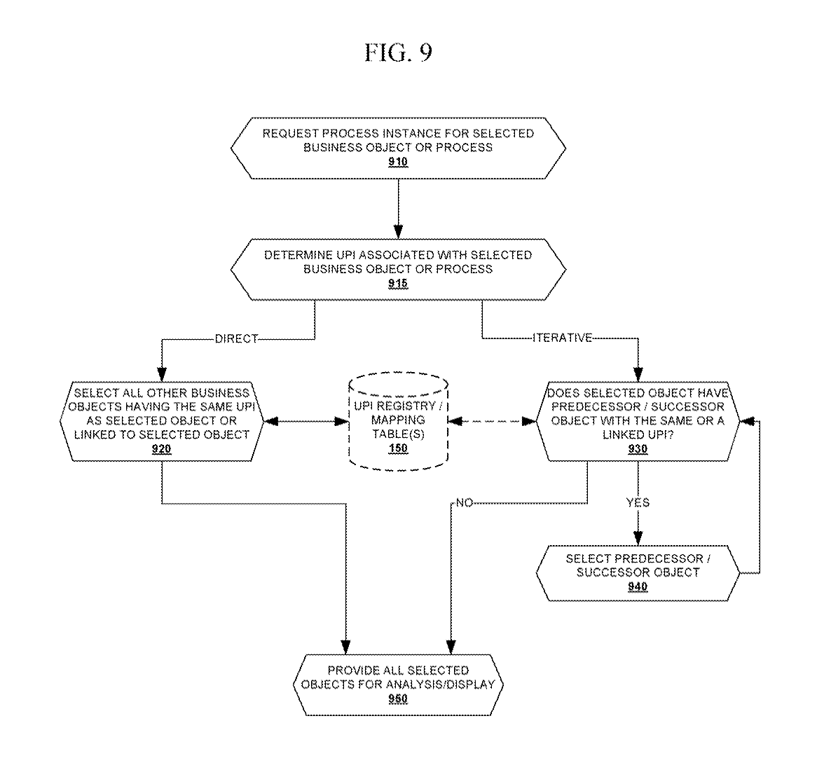

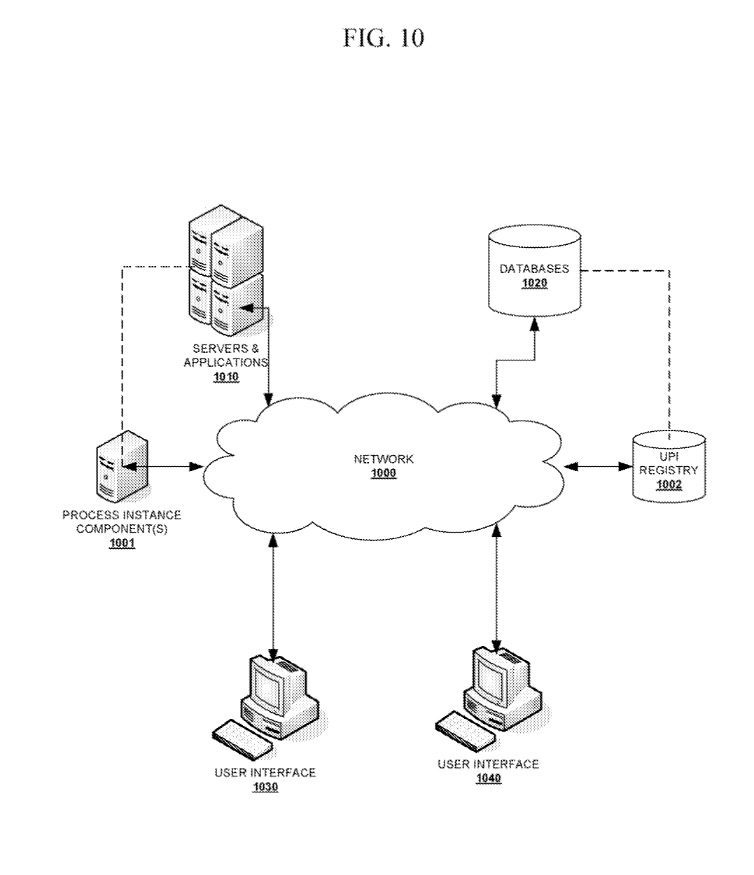

FIG. 9 shows an exemplary process for analyzing a process instance using UPIs according to an embodiment of the invention, A user of the business system may select a business object or process for which the process instance details are desired 910. For example, the user may wish to see the process instance resulting from a leave request submitted by an employee. As another example, the user may indicate a specific process, such as “sell from stock.” Such processes may be, for example, listed in a regular report generated by the system or requested by the user. In response to the user's request to view or analyze a process instance, the UPI of the selected business object or process may be determined 915. As previously explained, the process instance may be constructed directly, such as by selecting other objects having the same UPI, or iteratively, by examining each objects predecessor(s) and/or successor(s).

If a direct method is used, each object having the same UPI as the selected object or having the UPI associated with the selected process instance may be selected 920. For example, a UPI registry 150 may be queried to determine each business object associated with the UPI. If a mapping table was used, for example because the UPI propagation chain of the process instance to be analyzed was interrupted, a mapping table or tables 150 may also be queried to determine the relevant business objects. Once the associated business objects have been selected, they may be provided to the user 950. The business objects or information about the objects may be provided in a variety of formats, such as a graphical representation of the process instance, a flowchart showing steps in the process, textual details about each business object, or any other format.

If an iterative method is used, the selected object may be examined to determine the UPI of the selected object and whether the object has any predecessor and/or successor objects with the same UPI 930. If there are predecessor and/or successor objects with the same UPI, each may be selected 940 to determine whether the predecessor/successor object in turn has any predecessor/successor objects 930. Predecessor and/or successor objects may also be selected and examined if they are linked to the selected object via a mapping table 150. The process is repeated until the complete process instance has been assembled for analysis 950. As previously described, such an iterative method may be more time and/or computationally efficient than other iterative methods that may be used in the absence of a process instance identifier. The process instance may be provided to a user in the same manner as when the direct method is used.

An exemplary system implementing process instance identifiers according to the present invention is shown in FIG. 1. A business system may have one or more servers 1010 and databases 1020 in communication with one or more user interface terminals 1030, 1040. Servers in the business system may store and execute business objects, business applications, and other various objects and applications. As previously described, business objects are generated by applications in the business system. As used herein, a business object may be described without reference to an application, though it will be understood that each business object may be generated by and resident in an application. When two or more business objects are described, they may be contained within the same application or different applications. The user terminals 1030, 1040 implement user interfaces to the business system. Process instance components 1001, such as the applications necessary to implement process instance identifiers, may be part of the other applications in the system or may be separate components. Similarly, a UPI registry 1002 may be a separate storage component or may be implemented as part of other databases in the system. As shown, the various components of the business system may be connected via a network or directly connected. The specific arrangement and topology of servers, applications, systems, communication protocols, and connections are irrelevant to the invention unless specified otherwise herein. When users access the business system via user terminals 1030, 1040, business objects may be created and used to perform various tasks. As previously described, UPIs may be created by the various applications 1001, 1010 of the business system. Each process instance may be associated with a UPI, allowing for analysis of the instance. Information about UPIs and related business objects may be stored in various databases 1002, 1020 and other storage mechanisms within the business system.

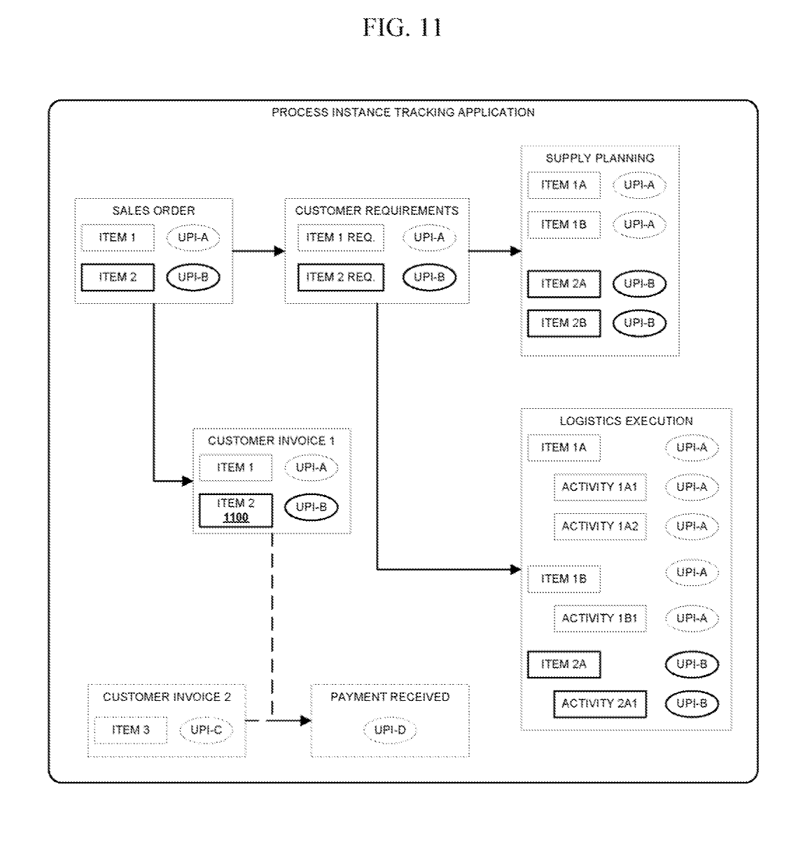

FIG. 11 shows an exemplary user interface for analyzing process instances. A variety of information and relationships may be shown, such as which business objects and/or nodes participate in a process instance, predecessor/successor relationships between business objects and nodes (i.e., causality relationships), the start and end of process chains within a larger framework, and other data and relationships. A user interface such as that shown in FIG. 6 may also be used to monitor business processes and/or display real process instances that have been executed in a business system. In the interface shown, business objects and nodes are shown with corresponding UPIs. The UPIs may be displayed, or they may be hidden from the user. As an example, a user of the system might request processes involved with Item 2 of Customer Invoice 1 (1100), which has UPI-B. An interface such as that shown might be used to display the relevant process instance(s). Predecessor/successor relationships may be shown; the example interface displays predecessor successor relationships using directed arrows. In an embodiment, related process instances and their relationships to the selected process instance may be shown. For example, related process instances may be displayed with dashed outlines. As another example, nodes that occur in business objects which are created during execution of the process instance but which are not themselves part of the instance may be shown with lighter or differently-colored outlines than those that are part of the selected instance. By selecting another displayed item, the user may view the process instance related to the newly-selected item. In an embodiment, a user interface such as that shown in FIG. 11 may also be used to monitor the progression of a process instance as it is executed in the business system and/or to design the elements of a process.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A business system comprising:
a process instance identifier registry to store identifiers assigned to process instances executed by the business system;
a mapping table to store links between process instance identifiers; and
a plurality of applications to generate business objects, each application having a database to store data specific to the respective application;
wherein one of the plurality of applications adds an entry to the mapping table when the propagation chain of a process instance identifier between business objects is interrupted.

2. The business system of claim 1, wherein the one of the plurality of applications is to communicate with a remote system.

3. The business system of claim 1, further comprising a user interface to display a schematic view of a process instance, wherein the process instance is associated with a process instance identifier assigned to one of the business objects.

4. A method of storing process instance information, comprising, responsive to creation of a new business object in a business system,
if the new business object is a first business object spawned by a predecessor business object, assigning a process instance identifier of the predecessor business object to the new business object; and
if the new business object is one of multiple business objects spawned by a common predecessor business object, assigning a process instance identifier to the new business object having a value that is different than process identifiers assigned to the other multiple business objects.

5. The method of claim 4, further comprising storing a record linking the process instance identifier of the predecessor business object to the new process instance identifier in a mapping table.

6. The method of claim 4, further comprising storing a record for each of the multiple business objects, each record linking the process instance identifier of the predecessor business object to the process instance identifier assigned to the business object in a mapping table.

7. A method of storing process instance information, comprising, in a business system,
responsive to receiving information from an external source, generating a new business object;
storing a process instance identifier in the new business object;
identifying a predecessor business object in the business system; and
storing a record identifying the predecessor business object and the new business object as part of the same process instance;
wherein the process instance identifier stored in the new business object has a different value than a process instance identifier stored in the predecessor object.

8. The method of claim 7 wherein the predecessor business object is identified by an internal identifier stored in a message received from the remote system.

9. The method of claim 7 wherein the predecessor business object is identified by an internal identifier created by an application generating the new business object.

10. The method of claim 7 wherein the external source is a remote system.

11. The method of claim 7 wherein the information received from an external source is received via a medium not implemented by the business system.

12. A method of retrieving process instance information, comprising, in a business system:
responsive to a user request for process instance information associated with a first business object, selecting a first process instance identifier assigned to the first business object;
sending a query containing the first process instance identifier to a mapping table, the mapping table storing a record linking a second process instance identifier to the first process instance identifier;
receiving a response to the query, the response containing the second process instance identifier;
selecting a second business object; and
displaying a schematic of a process instance;
wherein the second process instance identifier is assigned to the second business object, and wherein the first, and second business objects were generated during execution of the process instance.

13. The method of claim 12, further comprising:
sending a query containing the first process instance identifier to a process instance identifier registry;
receiving a response to the query, the response identifying a third business object; and
selecting the third business object;
wherein the first process instance identifier is assigned to the third business object, and the third business object was generated during execution of the process instance.

14. The method of claim 12, wherein the second business object to store data received via a communication channel not implemented by the business system.

15. A machine-readable medium containing program instructions for execution on a processor, which when executed cause the processor to perform:
responsive to creation of a new business object in a business system:
if the new business object is a first business object spawned by a predecessor business object, assigning a process instance identifier of the predecessor business object to the new business object; and
if the new business object is one of multiple business objects spawned by a common predecessor business object, assigning a process instance identifier to the new business object having a value that is different than process identifiers assigned to the other multiple business objects.

16. A machine-readable medium containing program instructions for execution on a processor, which when executed cause the processor to perform,
responsive to receiving information from an external source, generating a new business object;
assigning a process instance identifier to the new business object;
identifying a predecessor business object in the business system; and
storing a record identifying a process instance identifier assigned to the predecessor business object and the process instance identifier assigned to the new business object as part of the same process instance;
wherein the first process instance identifier has a different value than the second process instance identifier.
